(19) United States
(12) Patent Application Publication
(10) Pub. No.: US 2023/0214437 A1
(43) Pub. Date: Jul. 6, 2023

(54) QR CODE INITIATED CONTENT MANAGEMENT SYSTEM

(71) Applicant: Merkle Inc., Columbia, MD (US)

(72) Inventors: Valerie Vacante, Austin, TX (US); Chandrasekar Raju, Chicago, IL (US); Chris Hogue, Montclair, NJ (US)

(21) Appl. No.: 18/147,744

(22) Filed: Dec. 29, 2022

Related U.S. Application Data
(60) Provisional application No. 63/266,278, filed on Dec. 30, 2021.

(51) Int. Cl. G06F 16/955; G06Q 30/016; G06Q 30/0207

(52) U.S. Cl. CPC G06F 16/9554; G06Q 30/016; G06Q 30/0236

(57) ABSTRACT

A method and computer platform may administer a content management system for product templates with no specific programing code required for the retailer computer device to update a product template associated with the retailer. A URL can be associated with the updated template. When a request to access the URL is received from a mobile device, the URL or the updated template can be displayed to the mobile device, wherein the request is generated by the mobile device via scan of a QR code on a package.

### CROSS-REFERENCE TO RELATED APPLICATIONS

This non-provisional application claims the benefit of, and priority to, U.S. Provisional Application No. 63/266,278, entitled QR Code Initiated Content Management System, filed on Dec. 30, 2021, which is incorporated by reference in its entirety.

### FIELD OF THE DISCLOSURE

The present disclosure generally relates to a smart packaging content system and method, and more particularly to an application-free digital shopping, registration, and communication system and method.

### BACKGROUND

Retailers and their customers desire a simplified means for connecting with the product that they order and supporting information once it is delivered; product onboarding, instructions, learning more about product information (ingredients, how it is made, how it is cared for, storage,) related products, and the ability to register for more information, participate in loyalty programs, exclusive offers, subscription programs or social media community engagement to facilitate the shopping process and customer satisfaction.

Some retailers have employed QR codes on their shipping receipts or printed marketing materials however, these experiences are often driven to a generic company webpage.

Some retailers do not include any communication other than the physical receipt with no instruction or way for customers to connect with information about their product unless they manually research to find the specific website for the product that may not include the essential product instructions, onboarding or registration required to use the product, learn about ingredients, allergies, how it is made or exclusive offers otherwise hidden or difficult to find under multiple web pages within a retailer’s website.

Some retailers provide printed materials that are often outdated by the time they are shipped to a shopper’s home as a result costing the retailer incremental funds in reprinting and repackaging.

For some retailers it could take nearly a year or more to stand up a digital smart packaging content platform to work within their existing system with extensive training resulting in a significant time and financial investment.

Some retailers have native app experiences that enable shoppers to purchase additional items, provide customer ratings however they only provide a physical and digital receipt and do not include any digital product onboarding or specific experiences related to the product purchased.

These native application-based systems have been provided for iOS and Android devices; however, the application-based systems typically require customers to have a separate retailer-specific application downloaded to their personal communication devices in order to shop and/or use these application-based systems. Further, customers are somewhat tired of having to download specific applications, as the majority of U.S. consumers download zero applications per month.

### SUMMARY

Embodiments of the present disclosure may provide a QR code initiated content management system as an application-free, smart packaging content system and method, and more particularly to an application-free digital shopping, registration, communication and method. Retailers are able to update customized templates in a no code, content management system.

In some aspects, a computer implemented method includes: administering a content management system for product templates; receiving a request to display a product template to a retailer computer device; displaying, via an admin panel of the content management system, the product template to the retailer computer device; receiving, via the admin panel of the content management system from the retailer computer device, a first input including a modification of the product template; saving the modification of the product template as an updated template; receiving, via the admin panel of the content management system from the retailer computer device, a second input including a URL; associating the URL with the updated template; receiving a request to access the URL from a mobile device; and displaying the URL to the mobile device, wherein the request is generated by the mobile device via scan of a QR code on a package.

In some aspects, a computer platform has a processor, memory, and instructions stored on the memory that when executed, cause the processor to: administer a content management system for product templates; receive a request to display a product template to a retailer computer device; display, via an admin panel of the content management system, the product template to the retailer computer device; receive, via the admin panel of the content management system from the retailer computer device, a first input including a modification of the product template; save the modification of the product template as an updated template; receive, via the admin panel of the content management system from the retailer computer device, a second input including a URL; associate the URL with the updated template; receive a request to access the URL from a mobile device; and display the URL to the mobile device, wherein the request is generated by the mobile device via scan of a QR code on a package.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 illustrates a process flowchart for a computer system, and functionality for components of the computer system that is applicable to steps of the disclosed method.

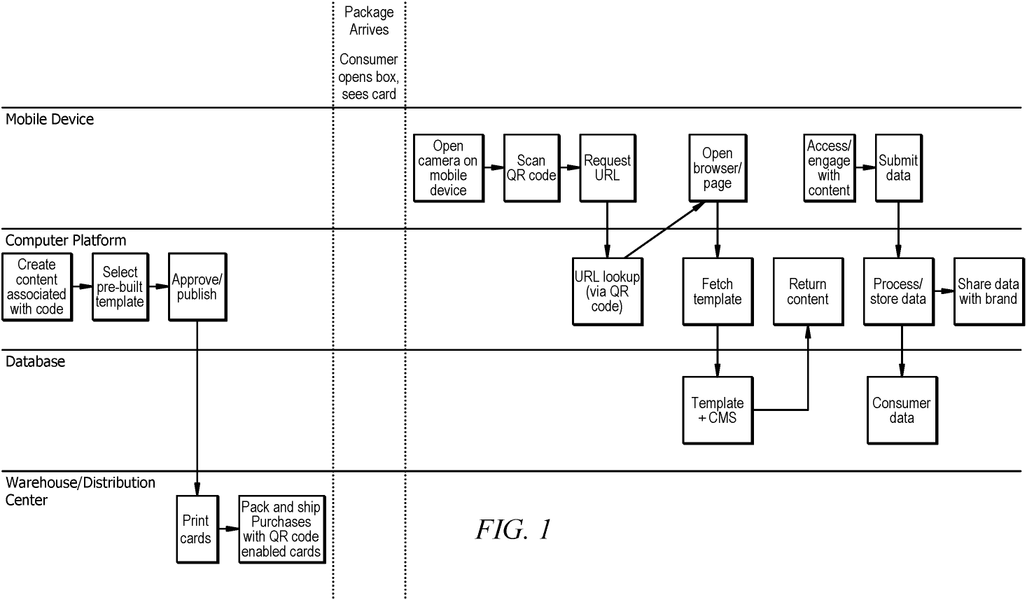

FIG. 2 illustrates an embodiment of an admin panel by which retailers access the content management system and manage the information for their products that is displayed by the computer platform to mobile devices after OR-code scans.

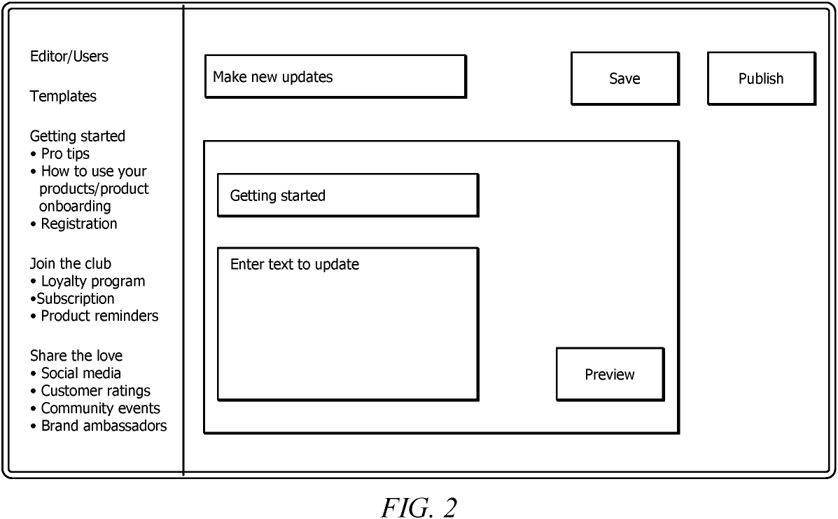

FIGS. 3A to 3C illustrate a series of screenshots of a mobile device displaying templates that are customized by a retailer through the admin panel.

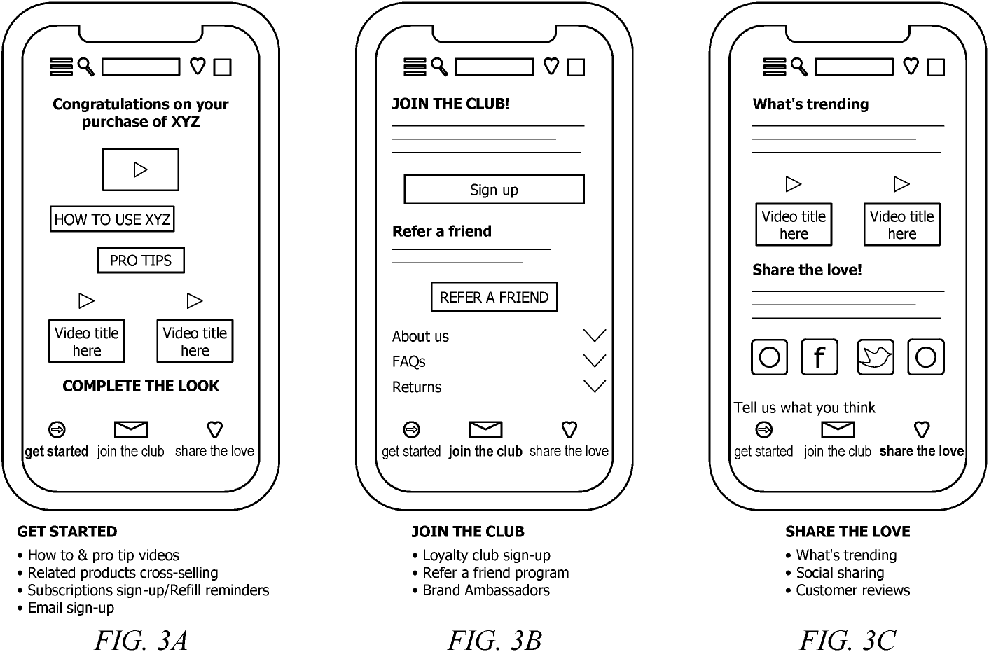

FIG. 4 illustrates aspects and features of the disclosure.

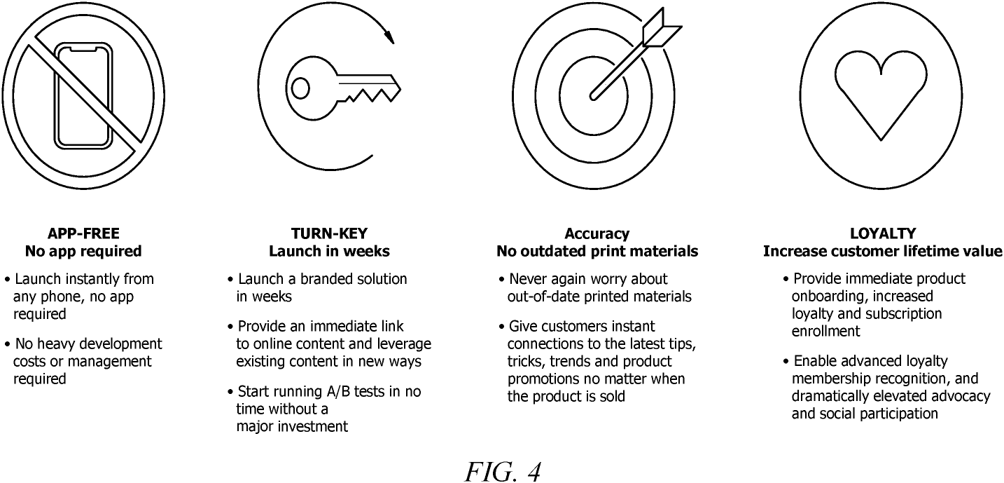

FIG. 5 illustrates a series of steps taken by a user of the mobile device and the interaction with the computer platform having retailer templates at a URL accessed after scanning the QR code.

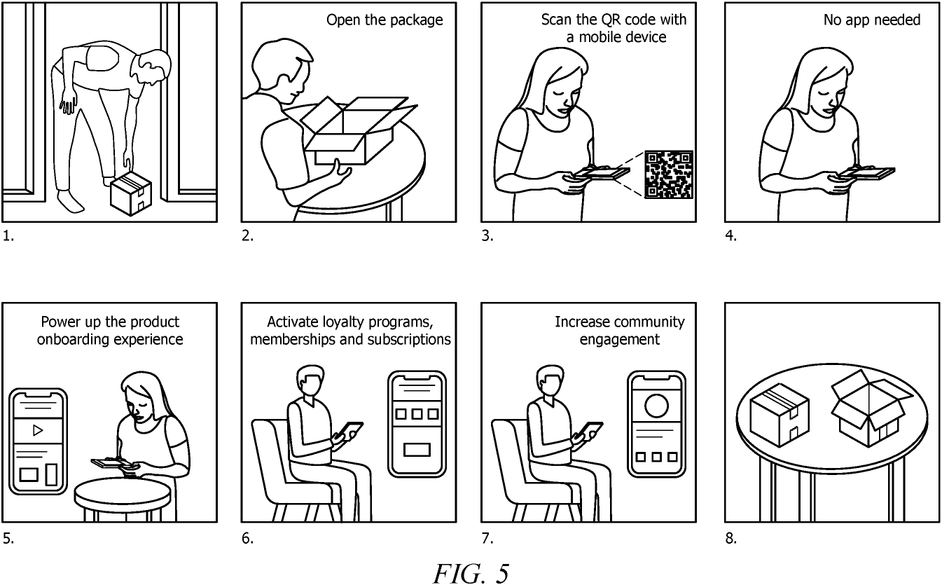

### DETAILED DESCRIPTION

The disclosed QR code initiated content management system may enable retailers to connect customers from the package that they receive on their doorstep to a retailer’s online content increasing email registrations, cross-selling opportunities, community engagement, customer satisfaction and lifetime value.

The embodiments disclosed herein can connect a customer’s mobile device directly to content that is tailored exclusively for the products delivered and content that can include a guided product specific experience, product onboarding, instructions, learning more about product information (ingredients, how it is made, how it is cared for, storage,) and the ability to register for more information, participate in loyalty programs, exclusive offers, subscription programs or social media community engagement to facilitate the shopping process and customer satisfaction.

Using their mobile device, customers may scan a QR code from the package that they receive on their doorstep to connect to valuable online content such as product onboarding, instructions, exclusive experiences, loyalty programs, subscriptions, customer ratings, social and community events.

The QR code directs the mobile device to a web page (e.g., via a URL embedded in the QR code). Through interaction on the mobile device on webpages (e.g., containing customized templates discussed herein) displayed by the disclosed computer platform on the mobile device, customers may select items to register for communications, loyalty programs and supporting marketing programs and make purchases on the retailer’s website without use of an application-based system.

The computer platform can include a database; alternatively, the database can be separate from the computer platform.

At least one mobile device can be networked with the computer platform, the database can be networked with the computer platform, and retailer computer devices can be networked with the computer platform.

Each of the computer components can be embodied with computer equipment such as one or more processors, memory, networking cards or interfaces, and other equipment for processing data.

Regarding network communication technology, the computer platform can be networked with the other components of the computer system via any wired internet connection, wireless connection, local area network (LAN), wired intranet connection, wireless intranet connection, or combinations thereof.

The computer platform can include one or more processors, memory, networking cards or interfaces, and other equipment for performing the method disclosed herein that does not require an additional application. The computer platform can include multiple computers, located in a brick-and-mortar location, local to the administrator of the computer platform, in the cloud, or a combination thereof. The computer platform can be configured to communicate simultaneously with multiple mobile devices and the database.

The computer platform contains a content management system. Retailers, via retailer computer devices, can use an admin panel provided and by the content management system (CMS) to update digital content on the templates that are displayed by the computer platform as web pages to which the QR code directs the mobile device, no matter when or where the product is sold or shipped.

The content management system includes an interactive admin panel that can be displayed by the computer platform on a computer device of a retailer. The computer device of the retailer can access the admin panel via login at a URL address for the admin panel, for example. The admin panel enables retailers to include / upload videos, text, imagery and existing website links from the retailer’s site or curated, selected content. No specific coding language is required to update content on the admin panel.

The no code content management system admin panel enables retailers to curate, edit, manage, preview, save and distribute their content using selected templates. In embodiments, the templates can include three pillars and supporting customer experiences: Getting Started, Join the Club, and Share the Love.

The three pillars and supporting templates are designed around the customer experience of receiving a package and connecting with the experience simply without an app on their mobile device.

### Getting Started - Power Up Product Onboarding Experiences

Help customers activate their onboarding experience with “how to” videos, tips, tricks and trends with customer support information to create a seamless onboarding and after care experience.

### Join the Club - Increase Membership, Loyalty and Subscriptions

Activate and launch loyalty programs, membership or subscriptions upon arrival to increase brand loyalty and recurring revenue from the get-go.

### Share the Love - Connect the Power of Community

Connect and reward customers for sharing their experiences with their community on social media. Increase customer satisfaction through surprise and delight opportunities.

The computer system is configured to be networked with any retailer computer device, and any number of different retailers and different retailer computer devices, such that each retailer computer device can access an admin panel for the respective retailer for customizing templates (e.g., templates of any of the three pillars disclosed herein) for display by the computer platform to a mobile device when a QR code relating to the template is scanned by the mobile device.

The computer platform can associate each template customized by a retailer with a URL that is administered by the computer platform, so that the computer platform can display the most recent version of the template customized by the retailer (saved to the computer platform via the CMS by a retailer device) to the mobile device that scanned the QR code having the URL embedded therein. The associations can be stored in a datastore of the computer platform. In embodiments, the URL associated with a template is the same URL that is embedded in the QR code. The computer platform can associate any number of URLs with any number of templates for a single retailer or any number of retailers, relieving the retailers of the burden of administering the content in the templates and allowing retailers to manage the content via the CMS of the computer platform.

In embodiments, the updated templates are made live by the computer platform (e.g., when a retailer accesses the admin panel and saves an update to a template, e.g., touches a “save” button and/or a “publish” button) in real-time after the retailer device sends instruction to save, such that the next mobile device that scans a QR code directing the mobile device to the URL of the updated template, the updated template is displayed by the computer platform.

In embodiments, the computer platform is configured to receive input from a mobile device, e.g., after the user of the mobile device interacts with a displayed template. The computer platform is configured to process and store data related to the input, for example, store data in the database. Processing data may include associating, by the computer platform, the input with the template from which the input was received, which links the input to the retailer that customized the template via the CMS. The computer platform can be further configured to send the input data that was received from the mobile device and associated with the retailer, to a retailer computer device.

Functionality of components of the computer system such as the computer platform has been discussed; however, it is to be understood that the functionality applies to the embodiments of the method.

The QR code initiated content management system can launch in weeks, increasing registrations, cross-selling and community engagement, while creating loyal, high lifetime value advocates.

### ADDITIONAL DESCRIPTION

Aspect 1. A computer implemented method comprising: administering a content management system for product templates; receiving a request to display a product template to a retailer computer device; displaying, via an admin panel of the content management system, the product template to the retailer computer device; receiving, via the admin panel of the content management system from the retailer computer device, a first input comprising a modification of the product template; saving the modification of the product template as an updated template; receiving, via the admin panel of the content management system from the retailer computer device, a second input comprising a URL; associating the URL with the updated template; receiving a request to access the URL from a mobile device; and displaying the URL or the updated template to the mobile device, wherein the request is generated by the mobile device via scan of a QR code on a package.

Aspect 2. The method of Aspect 1, performed simultaneously for a plurality of product templates associated with a plurality of retailers.

Aspect 3. The method of Aspect 1 or 2, further comprising: making the updated template live in real-time.

Aspect 4. The method of any of Aspects 1 to 3, wherein the modification of the product template comprises a video, text, a website link, or combinations thereof.

Aspect 5. The method of any of Aspects 1 to 4, wherein the admin panel is accessed by the retailer computer device via a login at a URL address for the admin panel.

Aspect 6. The method of any of Aspects 1 to 5, wherein the retailer computer device needs no specific coding language to generate the modification.

Aspect 7. The method of any of Aspects 1 to 6, wherein the URL is embedded in the QR code.

Aspect 8. Th method of any of Aspects 1 to 7, wherein the product template comprises customer onboarding content.

Aspect 9. The method of any of Aspects 1 to 8, wherein the product template comprises a loyalty program.

Aspect 10. The method of any of Aspects 1 to 9, wherein the product template comprises content for sharing a customer experience on social media.

Aspect 11. A computer platform having a processor, memory, and instructions stored on the memory that when executed, cause the processor to: administer a content management system for product templates; receive a request to display a product template to a retailer computer device; display, via an admin panel of the content management system, the product template to the retailer computer device; receive, via the admin panel of the content management system from the retailer computer device, a first input comprising a modification of the product template; save the modification of the product template as an updated template; receive, via the admin panel of the content management system from the retailer computer device, a second input comprising a URL; associate the URL with the updated template; receive a request to access the URL from a mobile device; and display the URL to the mobile device, wherein the request is generated by the mobile device via scan of a QR code on a package.

Aspect 12. The computer platform of Aspect 11, networked with a plurality of retailer computer devices, and configured to simultaneously perform functions of claim 11 for a plurality of product templates associated with a plurality of retailers via the content management system.

Aspect 13. The computer platform of Aspect 11 or 12, wherein the instructions further cause the processor to: make the updated template live in real-time.

Aspect 14. The computer platform of any of Aspects 11 to 13, wherein the modification of the product template comprises a video, text, a website link, or combinations thereof.

Aspect 15. The computer platform of any of Aspects 11 to 14, wherein the admin panel is accessed by the retailer computer device via a login at a URL address for the admin panel.

Aspect 16. The computer platform of any of Aspects 11 to 15, wherein the retailer computer device needs no specific coding language to generate the modification.

Aspect 17. The computer platform of any of Aspects 11 to 16, wherein the URL is embedded in the QR code.

Aspect 18. Th computer platform of any of Aspects 11 to 17, wherein the product template comprises customer onboarding content.

Aspect 19. The computer platform of any of Aspects 11 to 18, wherein the product template comprises a loyalty program.

Aspect 20. The computer platform of any of Aspects 11 to 19, wherein the product template comprises content for sharing a customer experience on social media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A computer implemented method comprising:
administering a content management system for product templates;
receiving a request to display a product template to a retailer computer device;
displaying, via an admin panel of the content management system, the product template to the retailer computer device;
receiving, via the admin panel of the content management system from the retailer computer device, a first input comprising a modification of the product template;
saving the modification of the product template as an updated template;
receiving, via the admin panel of the content management system from the retailer computer device, a second input comprising a URL;
associating the URL with the updated template;
receiving a request to access the URL from a mobile device; and
displaying the URL or the updated template to the mobile device, wherein the request is generated by the mobile device via scan of a QR code on a package.

2. The method of claim 1, performed simultaneously for a plurality of product templates associated with a plurality of retailers.

3. The method of claim 1, further comprising:
making the updated template live in real-time.

4. The method of claim 1, wherein the modification of the product template comprises a video, text, a website link, or combinations thereof.

5. The method of claim 1, wherein the admin panel is accessed by the retailer computer device via a login at a URL address for the admin panel.

6. The method of claim 1, wherein the retailer computer device needs no specific coding language to generate the modification.

7. The method of claim 1, wherein the URL is embedded in the QR code.

8. Th method of claim 1, wherein the product template comprises customer onboarding content.

9. The method of claim 1, wherein the product template comprises a loyalty program.

10. The method of claim 1, wherein the product template comprises content for sharing a customer experience on social media.

11. A computer platform having a processor, memory, and instructions stored on the memory that when executed, cause the processor to:
administer a content management system for product templates;
receive a request to display a product template to a retailer computer device;
display, via an admin panel of the content management system, the product template to the retailer computer device;
receive, via the admin panel of the content management system from the retailer computer device, a first input comprising a modification of the product template;
save the modification of the product template as an updated template;
receive, via the admin panel of the content management system from the retailer computer device, a second input comprising a URL;
associate the URL with the updated template;
receive a request to access the URL from a mobile device; and
display the URL to the mobile device, wherein the request is generated by the mobile device via scan of a QR code on a package.

12. The computer platform of claim 11, networked with a plurality of retailer computer devices, and configured to simultaneously perform functions of claim 11 for a plurality of product templates associated with a plurality of retailers via the content management system.

13. The computer platform of claim 11, wherein the instructions further cause the processor to:
make the updated template live in real-time.

14. The computer platform of claim 11, wherein the modification of the product template comprises a video, text, a website link, or combinations thereof.

15. The computer platform of claim 11, wherein the admin panel is accessed by the retailer computer device via a login at a URL address for the admin panel.

16. The computer platform of claim 11, wherein the retailer computer device needs no specific coding language to generate the modification.

17. The computer platform of claim 11, wherein the URL is embedded in the QR code.

18. Th computer platform of claim 11, wherein the product template comprises customer onboarding content.

19. The computer platform of claim 11, wherein the product template comprises a loyalty program.

20. The computer platform of claim 11, wherein the product template comprises content for sharing a customer experience on social media.
